(19) United States
(12) Patent Application Publication
(10) Pub. No.: US 2025/0145742 A1
(43) Pub. Date: May 8, 2025

(54) MEDIUM MOLECULAR POLYISOBUTENE WITH A HIGH CONTENT OF CERTAIN DOUBLE BOND ISOMERS

(71) Applicant: BASF SE, Ludwigshafen am Rhein (DE)

(72) Inventors: Svenja Wesp, Ludwigshafen am Rhein (DE); Markus Brym, Ludwigshafen am Rhein (DE); Paul Lederhose, Ludwigshafen am Rhein (DE)

(73) Assignee: BASF SE, Ludwigshafen am Rhein (DE)

(21) Appl. No.: 18/835,972

(22) PCT Filed: Feb. 9, 2023
(86) PCT No.: PCT/EP2023/053253

§ 371 Date: Aug. 5, 2024

(30) Foreign Application Priority Data
Feb. 11, 2022 (EP) 22156270.5
Feb. 3, 2023 (WO) PCT/EP2023/052636

(51) Int. Cl. C08F 10/10; C09D 123/22; C09J 123/22

(52) U.S. Cl. CPC C08F 10/10; C09D 123/22; C09J 123/22

(57) ABSTRACT

A medium molecular polyisobutene composition has a number-average molecular weight Mₙ of more than 10000 and up to 100000 g/mol with a high content of tetra-substituted double bond isomers from 20% to 75% in sum. The polyisobutene composition shows a high reactivity in thermal and/or photoreactions and/or radical backbone functionalisation and/or chlorine-based functionalisation.

The present invention concerns mixtures of polyisobutenes, preferably low or medium molecular polyisobutene, more preferably medium molecular polyisobutene with a number-average molecular weight Mn of more than 10000 and up to 100000 g/mol with a high content of tetra-substituted double bond isomers exhibiting a high reactivity in photoreactions and/or radical backbone functionalisation and/or chlorine-based functionalisation.

In the past efforts were made to prepare low molecular polyisobutene with a high reactivity for subsequent chemical reactions, e.g. subsequent hydroformylation, thermal ene-reaction with maleic anhydride, or Friedel-Crafts alkylation of aromatic compounds. As a result, highly reactive polyisobutene (also referred to as HRPIB) was developed with a high content of alpha-double bonds up to 80 to 90 mol % (see below for the designation of the isomers) or even higher contents up 95, 97 or even 98%.

Efforts to prepare polyisobutene with medium or high molecular weight and a high content of reactive double bonds are known from e.g. EP 807641 in which the cationic polymerisation of isobutene with a boron trifluoride complex catalyst is described. Claimed is a content of at least 50 mol % terminal double bonds although the terminal double bond content actually achieved in the explicitly disclosed examples and the distribution of isomers in the reaction mixture is not given.

A further disadvantage of EP 807641 is the recycling process in which unreacted isobutene is recycled to the reaction with the help of hexane. Although under the distillation conditions not all of the unreacted monomer is removed furthermore hexane is introduced into the polymer. Since both isobutene as well as hexane are toxic, polymers comprising such contaminants are not suitable for certain applications.

A high content of alpha- and/or beta-double bonds is necessary for medium molecular polyisobutene in order to achieve a high reactivity in thermal reactions, e.g. against maleic acid anhydride, see e.g. WO 2017/216022 where a polyisobutene with a number-average molecular weight Mₙ of 17000 g/mol and a content of alpha-double bond of 40% and of beta-double bonds of 47% is used in the examples. However, it has been found that alpha-double bonds are more reactive in thermal reactions than beta-double bonds.

Furthermore, the yield of a desired product is not only affected by the reactivity of the double bonds but also the distribution of the isomers carrying double bonds with different reactivity and the content of isomers bearing no double bond or a sterically hindered double bond which are not available for the reaction. WO 2017/216022 is silent about further isomers in the polyisobutene and structural elements thereof. Especially the content of isomers reactive in other reactions than the reaction with maleic acid anhydride is not given or rendered obvious.

Therefore, a need exists for compositions of medium molecular polyisobutene with which a high yield in following reactions can be achieved.

In the unpublished European Patent Application No. 20208053.7, filed 17. November 2020 (published as WO 2022/106263), a process for a photo oxygenation of low molecular polyisobutene was disclosed, in which the reactivity of the double bonds in polyisobutene towards singlet oxygen increases from alpha-double bonds to beta-double bonds and finally to other tri- and even tetra-substituted double bonds. However, due to their high reactivity such tetra-substituted double bonds tend to form double oxidised products rather than the singly oxidised products, i.e. the selectivity of the oxidation reaction decreases with an increased reactivity of the double bond. Tetra-substituted double bond isomers are, therefore, advantageous for applications in which polyisobutene derivatives are required bearing multiple oxidised functional groups close to each other. Furthermore, such tetra-substituted double bond isomers exhibit a low reactivity in thermal reactions and, therefore, are advantageous in applications with high thermal stress since they show less thermal degradation than polyisobutene with other double bonds. Additionaly the stability of radicals formed at those double bonds is increased which yield to more selective reactions. Furthermore, the polyisobutene deployed in the photo oxygenation described has a degree of polymerisation of approximately 100 at most which corresponds to a molecular weight of a maximum of 5600 g/mol and, hence, is low molecular. The reactivity of polyisobutene, however, is a function of its molecular weight and the reactivity of low molecular weight polyisobutene cannot be transferred to medium molecular weight.

In the examples of WO 2022/106263 low molecular weight polyisobutene is employed for which the relative distribution of double bond isomers is given, however, the absolute amount of each isomer in the polyisobutene composition is unknown.

Therefore, a need exists also for polyisobutene compositions with an increased content of tetra-substituted double bond isomers which renders the polyisobutene especially reactive in photoreactions, radical backbone functionalisation and chlorine-based functionalisations.

As an exemplary photo oxygenation the reaction of polyisobutene with oxygen was considered as described in the unpublished European Patent Application No. 20208053.7, filed 17. November 2020, published as WO 2022/106263.

Tetra-substituted double bonds exhibit a reactivity in photo oxygenations which is higher than that of beta-double bonds.

The reactivity of the double bonds isomers in polyisobutene in the photo oxygenation is preferably determined as described in the following: A photochemical batch reactor, equipped with eighty-eight 405 nm LEDs is charged with 10.0 g polyisobutene (Mn approx. 17000 g/mol, commercially available e.g. as Oppanol B10 from BASF SE, Ludwigshafen), 2.5 mg tetraphenylporphyrin and 66.5 g dichloromethane. Oxygen (1.5 NI/h) is bubbled through the reaction mixture while it is irradiated at 20° C. After 120 min the reaction is terminated. After evaporation of the solvent the reaction mixture is analysed by NMR spectroscopy.

In Macromolecules, 2011, 44 (7), pages 1831-1840, “Mechanism of Isomerization in the Cationic Polymerization”, R. Faust et al. disclose DFT calculations regarding the relative stability of different polyisobutene isomers.

While the tetra-substituted isomer (C4) is lowest in energy, another tetra-substitued isomer (C3) has an energy content of just 2.63 KJ/mol higher. In contrast the isomer (A) with an alpha-double bond is 30.46 KJ/mol higher and the isomer (B) is even 33.98 KJ/mol higher (for the designation of the isomers see below).

Hence, among these four isomers the isomer (B) is highest in energy and, therefore, under thermodynamic control of the reaction conditions expected to be formed least in equilibrium.

It is known that reactivity of the different double bond isomers in polyisobutene depends on the molecular weight. The reactivity of double bond isomers may be different in low, medium or high molecular weight polyisobutene. For example, it is known from WO 2017/216022, see e.g. Example 3, that under reaction conditions which lead to good yields of maleinated product for low molecular polyisobutene only minor amounts of product can be obtained if higher molecular weight polyisobutene is used. When using higher molecular weight polyisobutene a much higher stochiometry of maleic acid anhydride, higher reaction temperatures and/or longer reaction times are necessary to achieve comparable yields. Subject matter of the present invention is a polyisobutene composition comprising at least 5%(in sum) of at least one isomer bearing a tetra-substituted double bond, preferably selected from the group consisting of

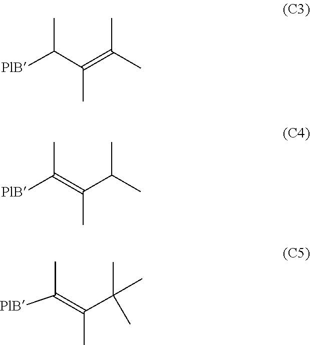

in which PIB, PIB′ and PIB″ refer to appropriately shortened polymeric backbones of the polyisobutene.

Further isomers which may be present in the polyisobutene composition are

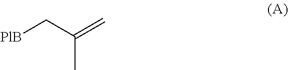

bearing an alpha-double bond,

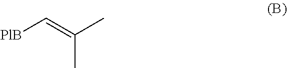

bearing a beta-double bond,

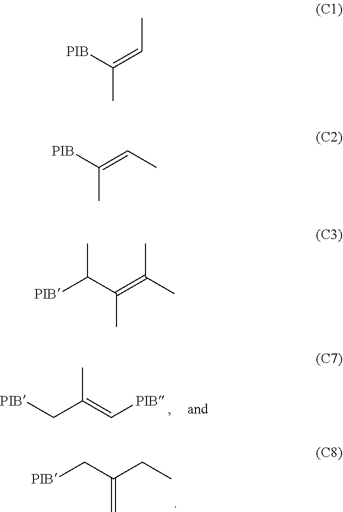

The polyisobutene composition may be low or medium molecular weight polyisobutene, as defined herein, preferably medium molecular weight polyisobutene.

In the above-listed formulae (A) to (C8) the groups PIB, PIB′ and respectively PIB″ together with the explicitly shown substructures add up to a polyisobutene polymer with a number-average molecular weight Mn of up to 10000 g/mol for low molecular weight polyisobutene and more than 10000 and up to 100000 g/mol for medium molecular weight polyisobutene. In other words, the groups PIB, PIB′ and respectively PIB″ refer to a polyisobutene polymer shortened by the explicitly shown substructures.

For low molecular polyisobutene with a number-average molecular weight Mn of up to 10000 g/mol the average degree of polymerisation is up to 177, preferably from 5 to 134, more preferably 6 to 107, even more preferably 9 to 89, especially 13 to 45, and even 16 to 20.

For medium molecular polyisobutene with a number-average molecular weight Mn of more than 10000 and up to 100000 g/mol the average degree of polymerisation is from 178 to 1786.

In an ideal homopolymer of isobutene the residues PIB, PIB′ and PIB″ stand for
PIB: −[—(H₃C)₂C—CH₂-]ₘ-,
PIB′: −[—(H₃C)₂C—CH₂-]ₙ- and
PIB″: −[—(H₃C)₂C—CH₂-]ₒ-,
wherein the polymer chain, especially of PIB and PIB′, may be started on an appropriate initiator, see below, preferably may be connected to hydrogen,
with m, n and o independently of another each being positive integers, with the proviso that the sum of m, n, and o plus the monomer units in the shown substructures match the degree of polymerisation of the low or medium molecular polyisobutene.

In a copolymer some isobutene units may be replaced by other monomer units, e.g. 1-butene, cis or trans 2-butene, see below.

In the case of formulae (A), (B), (C1) to (C5), and (C8) the integers m and n can be up to the degree of polymerisation of the low or medium molecular polyisobutene minus 1 or 2.

In the case of formulae (C6) and (C7) the integers n and o add up to the degree of polymerisation of the low or medium molecular polyisobutene minus 1.

The minimum amount of isomer (A) in the composition is at least 0.1%, preferably at least 0.25%, very preferably at least 0.5%.

The minimum amount of isomer (B) in the composition is at least 0.1%, preferably at least 0.25%, very preferably at least 0.5%.

The content of the isomers is determined with the help of ¹H-NMR spectroscopy, the detection level is determined by the frequency used. Preferably ¹H-NMR spectroscopy at 700 MHz at 25° C. is used. Very preferably the content of isomers is determined as described in Guo et al., Journal or Polymer Science, Part A: Polymer Chemistry, 2013, 51, 4200-4212.

Since the isomers are part of a polymeric mixture with a molecular weight distribution the content of each single isomer in the mixture in weight % and mol % is the same.

Another subject matter of the present invention is a process for preparation of such compositions with an increased content of tetra-substituted double bonds, comprising the steps of
choosing as a starting material a low or medium molecular polyisobutene composition with a content of polyisobutene species (A) bearing an alpha-double bond of at least 30 mol %, preferably at least 40 mol %, more preferably at least 50 mol %, most preferably at least 60 mol % and especially at least 70 mol %,
optionally at least one solvent,
treating the optionally dissolved polyisobutene composition
in the presence of at least one acidic solid state catalyst, optionally treated with at least one Brønsted-base
for a period of from 10 minutes to 36 hours
at a temperature of from 40° C. to 250° C.

In a preferred embodiment a low molecular polyisobutene composition is chosen as the starting material with a content of polyisobutene species (A) bearing an alpha-double bond of at least 50 mol %, preferably at least 60 mol %, more preferably at least 70 mol %, even more preferably at least 75 mol %, and especially at least 80 mol % or even at least 85 mol %. Low molecular weight polyisobutene with such a high content of alpha-double bonds is often referred to as “highly reactive polyisobutene”.

In another preferred embodiment a medium molecular polyisobutene composition is chosen as the starting material with a content of polyisobutene species (A) bearing an alpha-double bond of 10 to 60 mol %, preferably 15 to 55 mol %, more preferably 20 to 50 mol %, even more preferably 25 to 50 mol %, and especially at least 25 to 45 mol %. It is an advantage of such an embodiment that the relatively low content of thermally reactive double bonds, especially alpha-double bonds in such a medium molecular polyisobutene composition can be further depleted in the isomerisation process according to the present invention.

Sometimes, the content of polyisobutene species (A) bearing an alpha-double bond in the starting material may even preferably be at least 75 mol %, more preferably at least 80 mol %, most preferably at least 85 mol % and especially at least 90 mol %,

Another subject matter of the present invention is the use of such compositions with an increased content of tetra-substituted double bonds in reactions to obtain further derivatives, preferably in oxidation reactions, more preferably in photo oxygenations.

In the context of the present invention the term isomers bearing a “beta-double bond” refers to polyisobutene isomers (B) with the sub-structure

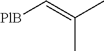

in which
“PIB” stands for the polymeric backbone of the polyisobutene except for the final incorporated isobutene unit.

In contrast, the term isomers bearing an “alpha-double bond” refers to polyisobutene isomers (A) with the sub-structure

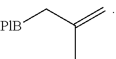

In the context of the present text “vinylidene double bonds” are referred to as double bonds bearing two hydrogen substituents on the same carbon atom of the double bond, if not explicitly mentioned otherwise. Such vinylidene double bonds may be terminal, such as in isomer (A), or internal, as in isomers (C6) or (C8).

Other polyisobutene isomers (C) may be

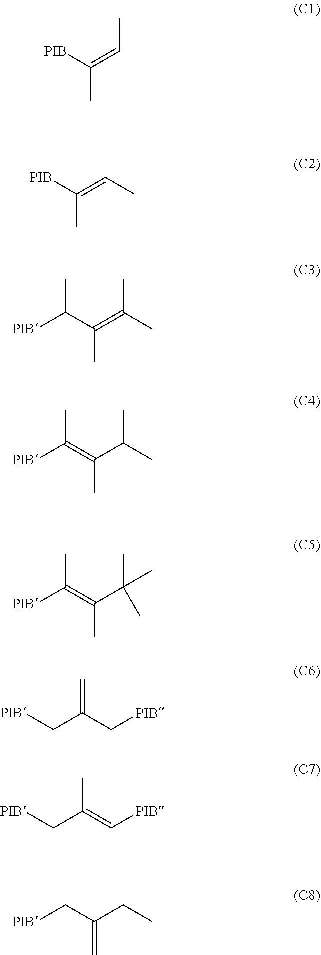

in which PIB′ and PIB″ refer to appropriately shortened polymeric backbones of the polyisobutene. Such a shortened polymeric backbone, especially PIB″, comprises at least one isobutene unit in polymerised form.

Further to components (A), (B), and (C) the mixture may comprise other polyisobutene-derived species (D):

Furthermore, halogenated polyisobutenes (D1) may be found.

Furthermore, fully saturated polyisobutenes (D2) may be found, which do not comprise any multiple bonds at all and are not halogenated.

Furthermore, it has been found that polyisobutene comprising a certain content of halogene, preferably fluorine or chlorine, exhibit a further improved reactivity in photo reactions. It is assumed that halogene, preferably chlorine acts as a kind of photosensitiser in photo reactions.

It constitutes a side aspect of the present invention to provide a low or medium molecular weight polyisobutene with a content of halogen, preferably fluorine or chlorine, more preferably chlorine, is more than 5 ppm by weight, preferably at least 10, more preferably at least 15, even more preferably at least 20, especially at least 30, and even at least 50 or 70 ppm by weight. The content refers to each halogene species.

The upper limit of the halogen, preferably fluorine or chlorine, more preferably chlorine, is usually up to 500, preferably up to 250, and more preferably up to 150 ppm by weight.

The content of halogene is determined by combustion ion chromatography (IC) analysis.

The halogen is preferably selected from the group consisting of fluorine, chlorine, and bromine, more preferably fluorine or chlorine, and especially chlorine.

Main origin of the halogen is the Lewis acid used as a catalyst for polymerisation or a halogen-containing initiator (see below), but can also be remaining solvent in the polyisobutene composition.

The halogen can be incorporated into the polyisobutene, such as isomer (D1) mentioned above, or can be part of the mixture without being chemically bound to polyisobutene.

Although isomers (C1) and (C2) also represent trisubstituted polyisobutene isomers with a beta-double bond they are distinguished from compound (B) since their reactivity in a photo oxygenation is different from compound (B): While compound (B) comprises six (nearly) equivalent hydrogen atoms on the two methyl groups in allylic position to the double bond which yield the same product on photo oxygenation, isomers (C1) and (C2) each comprise two different methyl groups which lead to different photo oxygenation products. Therefore, use of compound (B) in a photo oxygenation yields a more uniform reaction mixture, thus, compound (B) is preferred over compounds (C1) and (C2). It furthermore is assumed that compound (B) under reaction conditions of photo oxygenation appears to be less sterically hindered than isomers (C1) and (C2) which is a further advantage of polyisobutene compositions with a higher content of compound (B)

In the context of the present invention medium molecular polyisobutene is defined as polyisobutene compositions with a number-average molecular weight Mn of more than 10000 and up to 100000 g/mol.

The number-average molecular weight Mn (determined by gel permeation chromatography) of the medium molecular polyisobutene according to the present invention is from 10000 to 100000, preferably from 11000 to 90000, more preferably from 12000 to 80000, most preferably from 13000 to 75000, and especially from 14000 to 70000.

In contrast, low molecular polyisobutene is defined as polyisobutene compositions with a number-average molecular weight Mn of not more than 10000 g/mol, preferably 280 to 7500, more preferably 330 to 6000, even more preferably 500 to 5000, especially 750 to 2500, and even 900 to 1100 g/mol.

The polydispersity of the polyisobutene is from 1.2 to 10, preferably from 1.3 to 9, more preferably from 1.4 to 8, even more preferably from 1.5 to 6 and especially from 2 to 5.

Subject matter of the invention are polyisobutene compositions comprising at least 5% (in sum) of isomers with a tetrasubstituted double bond, preferably comprising at least one isomer selected from the group consisting of (C3), (C4), and (C5) together with their (E)- and (Z)-isomers (not shown) which represent tetrasubstituted isomers. The tetrasubstituted isomers are highly reactive in photo oxygenation and may lead to complex reaction mixtures due to their number of different reaction sites in photo oxygenation. It is an advantage of such tetrasubstituted isomers that a photo oxygenation of such isomers leads to reaction products bearing multiple oxidised functional groups close to each other. Such oxidised functional groups may in turn serve as starting functional groups for further functionalisation of the underlying polyisobutene. Suitable oxidised functional groups may be hydroperoxyl groups (—O—O—H), hydroxy groups (—OH), aldehyde groups (—CHO), keto groups (—(C═O)—) or carboxy groups (—COOH).

A tetrasubstituted double bond is defined as a double bond >C═C<in which both carbon atoms of the double bond are connected to other carbon atoms which serve as the connection to substituents. Preferred and illustrative examples are isomers (C3), (C4), and (C6).

Another conceivable isomer of polyisobutene with a tetrasubstituted double bond may be PIB′—C(CH₃)═C(CH₃)—PIB″ with an internal double bond.

The polyisobutene composition may comprise one or more tetrasubstituted isomers, preferably selected from the group consisting of (C3), (C4), and (C5). Usually the composition comprises a mixture of such tetrasubstituted isomers. In this invention the term “tetrasubstituted isomers” is used synonymously with the term “isomers with a tetrasubstituted double bond”

The amount of tetrasubstituted isomers is calculated as the sum of these tetrasubstituted isomers, preferably determined with ¹H-NMR spectroscopy as described above.

As pointed out above, the reactivity of the different double bond isomers in polyisobutene depends on the molecular weight. Furthermore, due to the different manufacturing processes low and medium molecular polyisobutene usually exhibits a different distribution of double bond isomers, therefore, the content of tetrasubstituted isomers according to the invention may be different for polyisobutene of different molecular weight:

Therefore, subject matter of the present invention is a medium molecular polyisobutene composition comprising at least 5% (in sum) of at least one isomer bearing a tetra-substituted double bond, preferably from 10 to 90%, even more preferably from 15 to 80%, especially 20 to 75%, and even 25 to 60%.

Another subject matter of the present invention is a low molecular polyisobutene composition comprising at least 5% or at least 10% (in sum) of at least one isomer bearing a tetra-substituted double bond, preferably from 15 to 95%, even more preferably from 20 to 80%, especially 30 to 75%, and even 45 to 60%.

The percentages given refer to the sum of all isomers with tetrasubstituted double bonds based upon the total amount of polyisobutene, preferably selected from the group consisting of isomers (C3), (C4), and (C5). The total amount of polyisobutene refers to the sum of all polyisobutene isomers (A) to (D) listed above.

Of course the proviso applies that the sum of all isomers always adds up to 100%.

However, it is an advantage of tetrasubstituted double bonds that they are less reactive in thermal reactions, therefore, the presence of isomers (C3), (C4), and (C5) is preferred when high-temperature reactions are performed with polyisobutene comprising such isomers, especially with polyisobutene comprising tetra-substituted end groups (C3).

For applications in which high-temperature reactions are unwanted polyisobutene compositions with a high amount of tetrasubstituted double bonds is preferred which have a low content of those polyisobutene isomers comprising a high reactivity in thermal reactions. These are preferably isomers (A), (C6), (C8), and (B), more preferably (A), (C6), and (C8), and even more preferably isomer (A).

The amount of such polyisobutene isomers (in sum) comprising a high reactivity in thermal reactions is usually not more than 50%, preferably not more than 40%, even more preferably not more than 30%, and especially not more than 25%.

Especially the content of isomer (A) in such compositions is not more than 20%, preferably not more than 15%, even more preferably not more than 10%, and especially not more than 5%.

Polyisobutene according to this embodiment has the advantage that is less reactive than polyisobutene according to the other embodiments and, therefore, is less susceptible to weathering and more stable against oxidation or thermal degradation. Therefore, composition comprising such polyisobutenes are especially useful in sealants, adhesives, coatings or roofings.

Isomers (C6) and (C7) are isomers with an internal double bond, since the double bond is at least one isobutene unit in polymerised form apart from the end of the polymer backbone, although isomer (C7) is less reactive than (C6) due to its double bond in the polymer backbone. This, again, emphasises the role of an accessible double bond in polyisobutenes.

Isomers (C6) are advantageous since they are known to yield fuel and lubricant additive derivatives with better performance properties, as disclosed in U.S. Pat. No. 9,688,791 B2. While isomer (C6) exhibits a higher reactivity especially in thermal reactions, isomer (C7) exhibits an advantage in photo reactions, especially photo oxygenations.

Isomer (C8) is the product of a methyl group rearrangement.

In another preferred embodiment at least one of isomers (C6) and (C8) is present in the compositions according to the present invention, preferably both (C6) and (C8).

In another preferred embodiment isomer (C7) is present in the compositions according to the present invention.

Such isomers independently of another are present in the compositions according to the present invention in amounts of at least 0.5 mol %, preferably at least 1 mol %.

The amounts of isomers given throughout the text refer to mol %, unless explicitly stated otherwise. Since the determination of the individual or groups of isomers is conducted by NMR analysis (details see below) the result of such NMR analysis is a percental distribution of certain

NMR signals of these isomers relative to the integral of the respective nucleus determined.

A further object of the present invention is a process for preparation of compositions according to the present invention, comprising the steps of
choosing as a starting material a polyisobutene composition with a content of polyisobutene species (A) bearing an alpha-double bond of at least 30 mol %, preferably at least 40 mol %, more preferably at least 50 mol %, most preferably at least 60 mol % and especially at least 70 mol %,
optionally at least one solvent,
treating the optionally dissolved polyisobutene composition
in the presence of at least one acidic solid state catalyst, optionally treated with at least one Brønsted-base
for a period of from 10 minutes to 36 hours
at a temperature of from 40° C. to 250° C.

In one embodiment of the present invention such process uses low molecular polyisobutene as a starting material.

In another embodiment of the present invention such process uses medium molecular polyisobutene as a starting material.

Processes for the preparation of such polyisobutene compositions with a higher content of alpha-double bonds are known in the prior art and are relevant for the present invention insofar that they are required for the preparation of the starting material of the process according to the present invention.

For the preparation of such polyisobutene compositions with a higher content of alpha-double bonds usually isobutene or an isobutenic starting material is polymerised in the presence of at least one Lewis Acid-donor complex and an initiator.

As a Lewis Acid usually metal halides are used, preferably halides of boron, aluminium, iron, gallium, titanium, zinc or tin.

Typical examples are boron trifluoride, boron trichloride, aluminum trihalide, alkylaluminum dihalide, dialkylaluminum halide, iron trihalide, gallium trihalide, titanium tetrahalide, zinc dihalide, tin dihalide, tin tetrahalide, wherein the halide is preferably fluoride or chloride, more preferably chloride.

Preferred are boron trifluoride, aluminum trichloride, alkyl aluminum dichloride, dialkyl aluminum chloride, and iron trichloride, more preferred are boron trifluoride, aluminum trichloride, and alkyl aluminum dichloride, most preferred are boron trifluoride and aluminum trichloride with boron trifluoride being especially preferred.

Examples for suitable donor compounds comprise at least one oxygen and/or nitrogen atom with at least one lone electron pair, preferably at least one oxygen atom with at least one lone electron pair and very preferably are selected from the group consisting of organic compounds with at least one ether function, organic compounds with at least one carboxylic ester function, organic compounds with at least one aldehyde function, organic compounds with at least one keto function, and organic compounds with at least one nitrogen containing heterocyclic ring.

Solely oxygen containing donor compounds are preferred over nitrogen-containing donor compounds.

Preferably the donor is selected from the group consisting of organic compounds with at least one ether function, organic compounds with at least one carboxylic ester function and organic compounds with at least one keto function, more preferably selected from the group consisting of organic compounds with at least one ether function and organic compounds with at least one carboxylic ester function, very preferably donors are organic compounds with at least one ether function, and especially organic compounds with exactly one ether function.

Compounds with at least one ether function are also understood to mean acetals and hemiacetals. The ether compound may comprise one or more ether functions, e.g. one, two, three, four or even more ether functions, preferably one or two ether functions and very preferably one ether function.

The mixture of donors may comprise one, two, three, four or even more different compounds, preferably compounds with at least one ether function, preferably one or two different compounds and very preferably one compound.

It may be an advantage to use a mixture of two different donors, especially two different ethers, see e.g. WO 2017/1140603 for aluminium halide-donor complexes

In a preferred embodiment of the present invention, a boron trihalide-donor complex, an aluminum trihalide-donor complex or an alkylaluminum halide complex, or an iron trihalide-donor complex, or a gallium trihalide-donor complex or a titanium tetrahalide-donor complex or a zinc dihalide-donor complex or a tin dihalide-donor complex or the tin tetrahalide-donor complex or the boron trihalide-donor complex, very preferably a boron trihalide-donor complex, an aluminum trihalide-donor complex or an iron trihalide-donor complex or a boron trihalide-donor complex and especially a boron trihalide-donor complex or an aluminum trihalide-donor complex is used, which comprises, as the donor, at least one dihydrocarbyl ether the general formula R⁸—OR⁹ in which the variables R⁸ and R⁹ are each independently C₁—to C₂₀-alkyl radicals, preferably C₁—to C₈ alkyl radicals especially C₁—to C₄ alkyl radicals, C₁—to C₂₀-haloalkyl radicals, preferably C₁—to C₈ haloalkyl radicals especially C₁—to C₄ haloalkyl radicals, C₅—to C₈-cycloalkyl radicals, preferably C₅—to C₆-cycloalkyl radicals, C₆—to C₂₀-aryl radicals, especially C₆—to C₁₂ aryl radicals, C₆—to C₂₀-haloaryl radicals, especially C₆—to C₁₂ haloaryl radicals, or C₇—to C₂₀-arylalkyl radicals, especially C₇—to C₁₂-arylalkyl radicals. Preference is given to C₁—to C₄ alkyl radicals, C₁—to C₄ haloalkyl radicals, C₆—to C₁₂ aryl radicals, and C₇—to C₁₂-arylalkyl radicals

Haloalkyl and haloaryl mean preferably chloroalkyl or bromoalkyl and chloroaryl or bromoaryl, very preferably chloroalkyl and chloroaryl. Especially preferred are w-haloalkyl radicals.

Preferred examples are chloromethyl, 1-chloroeth-1-yl, 2-chloroeth-1-yl, 2-chloroprop-1-yl, 2-chloroprop-2-yl, 3-chloroprop-1-yl, and 4-chlorobut-1-yl.

Preferred examples for chloroaryl are 2-chlorophenyl, 3-chlorophenyl, and 4-chlorophenyl.

The dihydrocarbyl ethers mentioned may be open-chain or cyclic, where the two variables R⁸ and R⁹ in the case of the cyclic ethers may join to form a ring, where such rings may also comprise two or three ether oxygen atoms. Examples of such open-chain and cyclic dihydrocarbyl ethers are dimethyl ether, chloromethyl methyl ether, bis(chloromethyl) ether, diethyl ether, chloromethyl ethyl ether, 2-chloroethyl ethyl ether (CEE), bis(2-chloroethyl) ether (CE), di-npropyl ether, diisopropyl ether, di-n-butyl ether, di-sec-butyl ether, diisobutyl ether, di-n-pentyl ether, di-n-hexyl ether, di-n-heptyl ether, di-n-octyl ether, di-(2-ethylhexyl) ether, methyl n-butyl ether, methyl sec-butyl ether, methyl isobutyl ether, methyl tert-butyl ether, ethyl n-butyl ether, ethyl sec-butyl ether, ethyl isobutyl ether, ethyl tert-butyl ether, n-propyl-n-butyl ether, n-propyl sec-butyl ether, n-propyl isobutyl ether, n-propyl tert-butyl ether, isopropyl n-butyl ether, isopropyl sec-butyl ether, isopropyl isobutyl ether, isopropyl tert-butyl ether, methyl n-hexyl ether, methyl n-octyl ether, methyl 2-ethylhexyl ether, ethyl n-hexyl ether, ethyl n-octyl ether, ethyl 2-ethylhexyl ether, n-butyl n-octyl ether, n-butyl 2-ethylhexyl ether, tetrahydrofuran, tetrahydropyran, 1,2-, 1,3- and 1,4-dioxane, dicyclohexyl ether, diphenyl ether, alkyl aryl ethers, such as anisole and phenetole, ditolyl ether, dixylyl ether and dibenzyl ether.

Furthermore, difunctional ethers such as dialkoxybenzenes, preferably dimethoxybenzenes, very preferably veratrol, and ethylene glycol dialkylethers, preferably ethylene glycol dimethylether and ethylene glycol diethylether, are preferred.

Among the dihydrocarbyl ethers mentioned, diethyl ether, 2-chloroethyl ethyl ether, diisopropyl ether, di-n-butyl ether and diphenyl ether have been found to be particularly advantageous as donors for the boron trihalide-donor complexes, the aluminum trihalide-donor complexes or the alkylaluminum halide complexes or the iron trihalide-donor complexes or the gallium trihalidedonor complex or the titanium tetrahalide-donor complex or the zinc dihalide-donor complex or the tin dihalide-donor complex or the tin tetrahalide-donor complex or the boron trihalide-donor complex, very preferably boron trihalide-donor complexes, the aluminum trihalide-donor complexes or iron trihalide-donor complexes or boron trihalide-donor complex and especially the a boron trihalide-donor complexes or the aluminum trihalide-donor complexes.

In a preferred embodiment dihydrocarbyl ethers with at least one secondary or tertiary dihydrocarbyl group are preferred over dihydrocarbyl groups with primary groups only. Ethers with primary dihydrocarbyl groups are those ethers in which both dihydrocarbyl groups are bound to the ether functional group with a primary carbon atom, whereas ethers with at least one secondary or tertary dihydrocarbyl group are those ethers in which at least one dihydrocarbyl group is bound to the ether functional group with a secondary or tertiary carbon atom.

For the sake of clarity, e.g. diisobutyl ether is deemed to be an ether with primary dihydrocarbyl groups, since the secondary carbon atom of the isobutyl group is not bound to the oxygen of the functional ether group but the hydrocarbyl group is bound via a primary carbon atom.

Preferred examples for ethers with primary dihydrocarbyl groups are diethyl ether, di-n-butyl ether, and di-n-propyl ether.

Preferred examples for ethers with at least one secondary or tertary dihydrocarbyl group are diisopropyl ether, methyl tert-butyl ether, ethyl tert-butyl ether, and anisole.

In addition, particularly advantageous dihydrocarbyl ethers as donors for the boron trihalidedonor complexes, the aluminum trihalide-donor complexes or the alkylaluminum halide complexes, have been found to be those in which the donor compound has a total carbon number of 3 to 16, preferably of 4 to 16, especially of 4 to 12, in particular of 4 to 8.

In another preferred embodiment halide-substituted ethers are preferred in combination with aluminum halide-donor complex or iron halide-donor complex or boron halide-donor complex.

Organic compounds with at least one carboxylic ester function are preferably hydrocarbyl carboxylates of the general formula R¹⁰—COOR¹¹ in which the variables R¹⁰ and R¹¹ are each independently C₁—to C₂₀-alkyl radicals, especially C₁—to C₈ alkyl radicals, C₅—to C₈-cycloalkyl radicals, C₆—to C₂₀-aryl radicals, especially C₆—to C₁₂ aryl radicals, or C₇—to C₂₀-arylalkyl radicals, especially C₇-to C₁₂-arylalkyl radicals.

Examples of the hydrocarbyl carboxylates mentioned are methyl formate, ethyl formate, n-propyl formate, isopropyl formate, n-butyl formate, sec-butyl formate, isobutyl formate, tert-butyl formate, methyl acetate, ethyl acetate, n-propyl acetate, isopropyl acetate, n-butyl acetate, secbutyl acetate, isobutyl acetate, tert-butyl acetate, methyl propionate, ethyl propionate, n-propyl propionate, isopropyl propionate, n-butyl propionate, sec-butyl propionate, isobutyl propionate, tert-butyl propionate, methyl butyrate, ethyl butyrate, n-propyl butyrate, isopropyl butyrate, n-butyl butyrate, sec-butyl butyrate, isobutyl butyrate, tert-butyl butyrate, methyl cyclohexanecarboxylate, ethyl cyclohexanecarboxylate, n-propyl cyclohexanecarboxylate, isopropyl cyclohexanecarboxylate, n-butyl cyclohexanecarboxylate, sec-butyl cyclohexanecarboxylate, isobutyl cyclohexanecarboxylate, tert-butyl cyclohexanecarboxylate, methyl benzoate, ethyl benzoate, n-propyl benzoate, isopropyl benzoate, n-butyl benzoate, sec-butyl benzoate, isobutyl benzoate, tertbutyl benzoate, methyl phenylacetate, ethyl phenylacetate, n-propyl phenylacetate, isopropyl phenylacetate, n-butyl phenylacetate, sec-butyl phenylacetate, isobutyl phenylacetate and tertbutyl phenylacetate. Among the hydrocarbyl carboxylates mentioned, ethyl acetate has been found to be particularly advantageous as a donor for the complexes.

In addition, particularly advantageous hydrocarbyl carboxylates as donors, have been found to be those in which the donor compound has a total carbon number of 3 to 16, preferably of 4 to 16, especially of 4 to 12, in particular of 4 to 8, preference is given in particular to those having a total of 3 to 10 and especially 4 to 6 carbon atoms.

Organic compounds with at least one aldehyde function, preferably exactly one aldehyde function and organic compounds with at least one keto function, preferably exactly one keto function typically have from 1 to 20, preferably from 2 to 10 carbon atoms. Functional groups other than the carbonyl group are preferably absent.

Preferred organic compounds with at least one aldehyde function are those of formula R¹⁰—CHO, in which R¹⁰has the above-mentioned meaning, very preferably are selected from the group consisting of formaldehyde, acetaldehyde, propionaldehyde, n-butyraldehyde, isobutyraldehyde, and benzaldehyde.

Preferred organic compounds with at least one keto function are those of formula R¹⁰—(C═O)R¹¹, in which R¹⁰ and R¹¹ have the above-mentioned meaning, very preferably are selected from the group consisting of acetone, methyl ethyl ketone, diethyl ketone, methyl isobutyl ketone, cyclohexanone, acetophenone, and benzophenone. Greatest preference is given to acetone.

Organic compounds with at least one nitrogen containing heterocyclic ring are preferably saturated, partly unsaturated or unsaturated nitrogen-containing five-membered or six-membered heterocyclic rings which comprises one, two or three ring nitrogen atoms and may have one or two further ring heteroatoms from the group of oxygen and sulphur and/or hydrocarbyl radicals, especially C₁—to C₄-alkyl radicals and/or phenyl, and/or functional groups or heteroatoms as substituents, especially fluorine, chlorine, bromine, nitro and/or cyano, for example pyrrolidine, pyrrole, imidazole, 1,2,3- or 1,2,4-triazole, oxazole, thiazole, piperidine, pyrazane, pyrazole, pyridazine, pyrimidine, pyrazine, 1,2,3-, 1,2,4- or 1,2,5-triazine, 1,2,5-oxathiazine, 2H-1,3,5-thiadiazine or morpholine.

However, a very particularly suitable nitrogen-containing basic compound of this kind is pyridine or a derivative of pyridine (especially a mono-, di- or tri-C₁—to C₄-alkyl-substituted pyridine) such as 2-, 3-, or 4-methylpyridine (picolines), 2,3-, 2,4-, 2,5-, 2,6-, 3,4-, 3,5- or 3,6-dimethylpyridine (lutidines), 2,4,6-trimethylpyridine (collidine), 2-, 3, - or 4-tert-butylpyridine, 2-tert-butyl-6-methylpyridine, 2,4-, 2,5-, 2,6- or 3,5-di-tert-butylpyridine or else 2-, 3, - or 4-phenylpyridine.

### Initiator:

The polymerization is preferably performed with additional use of a mono- or polyfunctional, especially mono-, di- or trifunctional, initiator which is selected from organic hydroxyl compounds, organic halogen compounds and water. It is also possible to use mixtures of the initiators mentioned, for example mixtures of two or more organic hydroxyl compounds, mixtures of two or more organic halogen compounds, mixtures of one or more organic hydroxyl compounds and one or more organic halogen compounds, mixtures of one or more organic hydroxyl compounds and water, or mixtures of one or more organic halogen compounds and water. The initiator may be mono-, di- or polyfunctional, i.e. one, two or more hydroxyl groups or halogen atoms, which start the polymerization reaction, may be present in the initiator molecule. In the case of di- or polyfunctional initiators, telechelic isobutene polymers with two or more, especially two or three, polyisobutene chain ends are typically obtained.

Organic hydroxyl compounds which have only one hydroxyl group in the molecule and are suitable as monofunctional initiators include especially alcohols and phenols, in particular those of the general formula R¹²—OH, in which R¹² denotes C₁—to C₂₀-alkyl radicals, especially C₁—to C₈-alkyl radicals, C₅—to C₈-cycloalkyl radicals, C₆—to C₂₀-aryl radicals, especially C₆—to C₁₂-aryl radicals, or C₇—to C₂₀-arylalkyl radicals, especially C₇—to C₁₂-arylalkyl radicals. In addition, the R¹² radicals may also comprise mixtures of the abovementioned structures and/or have other functional groups than those already mentioned, for example a keto function, a nitroxide or a carboxyl group, and/or heterocyclic structural elements.

Typical examples of such organic monohydroxyl compounds are methanol, ethanol, n-propanol, isopropanol, n-butanol, sec-butanol, isobutanol, tert-butanol, n-pentanol, n-hexanol, n-heptanol, n-octanol, 2-ethylhexanol, cyclohexanol, phenol, p-methoxyphenol, o-, m- and p-cresol, benzyl alcohol, p-methoxybenzyl alcohol, 1- and 2-phenylethanol, 1- and 2-(p-methoxyphenyl) ethanol, 1-, 2- and 3-phenyl-1-propanol, 1-, 2- and 3-(p-methoxyphenyl)-1-propanol, 1- and 2-phenyl-2-propanol, 1- and 2-(p-methoxyphenyl)-2-propanol, 1-, 2-, 3- and 4-phenyl-1-butanol, 1-, 2-, 3- and 4-(p-methoxyphenyl)-1-butanol, 1-, 2-, 3- and 4-phenyl-2-butanol, 1-, 2-, 3- and 4-(p-methoxyphenyl)-2-butanol, 9-methyl-9H-fluoren-9-ol, 1,1-diphenylethanol, 1,1-diphenyl-2-propyn-1-ol, 1,1-diphenylpropanol, 4-(1-hydroxy-1-phenylethyl)benzonitrile, cyclopropyldiphenylmethanol, 1-hydroxy-1,1-diphenylpropan-2-one, benzilic acid, 9-phenyl-9-fluorenol, triphenylmethanol, diphenyl(4-pyridinyl) methanol, alpha, alpha-diphenyl-2-pyridinemethanol, 4-methoxytrityl alcohol (especially polymer-bound as a solid phase), alpha-tert-butyl-4-chloro-4′-methylbenzhydrol, cyclohexyldiphenylmethanol, alpha-(p-tolyl)-benzhydrol, 1,1,2-triphenylethanol, alpha, alphadiphenyl-2-pyridineethanol, alpha, alpha-4-pyridylbenzhydrol N-oxide, 2-fluorotriphenylmethanol, triphenylpropargyl alcohol, 4-[(diphenyl) hydroxymethyl]benzonitrile, 1-(2,6-dimethoxyphenyl)-2-methyl-1-phenyl-1-propanol, 1,1,2-triphenylpropan-1-ol and p-anisaldehyde carbinol.

In a preferred embodiment it is possible to use a mixture of primary and secondary alcohols as initiators, as described in WO 2013/120859.

Organic hydroxyl compounds which have two hydroxyl groups in the molecule and are suitable as bifunctional initiators are especially dihydric alcohols or diols having a total carbon number of 2 to 30, especially of 3 to 24, in particular of 4 to 20, and bisphenols having a total carbon number of 6 to 30, especially of 8 to 24, in particular of 10 to 20, for example ethylene glycol, 1,2- and 1,3-propylene glycol, 1,4-butylene glycol, 1,6-hexylene glycol, 1,2-, 1,3- or 1,4-bis(1-hydroxy-1-methylethyl)benzene (o-, m- or p-dicumyl alcohol), bisphenol A, 9,10-di-hydro-9, 10-dimethyl-9,10-anthracenediol, 1,1-diphenylbutane-1,4-diol, 2-hydroxytriphenylcarbinol and 9-[2-(hydroxymethyl)phenyl]-9-fluorenol.

Organic halogen compounds which have one halogen atom in the molecule and are suitable as monofunctional initiators are in particular compounds of the general formula R¹³-Hal in which Hal is a halogen atom selected from fluorine, iodine and especially chlorine and bromine, and R¹³ denotes C₁—to C₂₀-alkyl radicals, especially C₁—to C₈-alkyl radicals, C₅—to C₈-cycloalkyl radicals or C₇—to C₂₀-arylalkyl radicals, especially C₇—to C₁₂-arylalkyl radicals. In addition, the R¹³ radicals may also comprise mixtures of the abovementioned structures and/or have other functional groups than those already mentioned, for example a keto function, a nitroxide or a carboxyl group, and/or heterocyclic structural elements.

Typical examples of such monohalogen compounds are methyl chloride, methyl bromide, ethyl chloride, ethyl bromide, 1-chloropropane, 1-bromopropane, 2-chloropropane, 2-bromopropane, 1-chlorobutane, 1-bromobutane, sec-butyl chloride, sec-butyl bromide, isobutyl chloride, isobutyl bromide, tert-butyl chloride, tert-butyl bromide, 1-chloropentane, 1-bromopentane, 1-chlorohexane, 1-bromohexane, 1-chloroheptane, 1-bromoheptane, 1-chlorooctane, 1-bromooctane, 1-chloro-2-ethylhexane, 1-bromo-2-ethylhexane, cyclohexyl chloride, cyclohexyl bromide, benzyl chloride, benzyl bromide, 1-phenyl-1-chloroethane, 1-phenyl-1-bromoethane, 1-phenyl-2-chloroethane, 1-phenyl-2-bromoethane, 1-phenyl-1-chloropropane, 1-phenyl-1-bromopropane, 1-phenyl-2-chloropropane, 1-phenyl-2-bromopropane, 2-phenyl-2-chloropropane, 2-phenyl-2-bromopropane, 1-phenyl-3-chloropropane, 1-phenyl-3-bromopropane, 1-phenyl-1-chlorobutane, 1-phenyl-1-bromobutane, 1-phenyl-2-chlorobutane, 1-phenyl-2-bromobutane, 1-phenyl-3-chlorobutane, 1-phenyl-3-bromobutane, 1-phenyl-4-chlorobutane, 1-phenyl-4-bromobutane, 2-phenyl-1-chlorobutane, 2-phenyl-1-bromobutane, 2-phenyl-2-chlorobutane, 2-phenyl-2-bromobutane, 2-phenyl-3-chlorobutane, 2-phenyl-3-bromobutane, 2-phenyl-4-chlorobutane and 2-phenyl-4-bromobutane.

Organic halogen compounds which have two halogen atoms in the molecule and are suitable as difunctional initiators are, for example, 1,3-bis(1-bromo-1-methylethyl)benzene, 1,3-bis(2-chloro-2-propyl)benzene (1,3-dicumyl chloride) and 1,4-bis(2-chloro-2-propyl)benzene (1,4-dicumyl chloride).

The initiator is more preferably selected from organic hydroxyl compounds in which one or more hydroxyl groups are each bonded to an sp3-hybridized carbon atom, organic halogen compounds, in which one or more halogen atoms are each bonded to an sp3-hybridized carbon atom, and water. Among these, preference is given in particular to an initiator selected from organic hydroxyl compounds in which one or more hydroxyl groups are each bonded to an sp3-hybridized carbon atom.

In the case of the organic halogen compounds as initiators, particular preference is further given to those in which the one or more halogen atoms are each bonded to a secondary or especially to a tertiary sp3-hybridized carbon atom.

Preference is given in particular to initiators which may bear, on such an sp3-hydridized carbon atom, in addition to the hydroxyl group, the R¹², R¹³ and R¹⁴ radicals, which are each independently hydrogen, C₁—to C₂₀-alkyl, C₅—to C₈-cycloalkyl, C₆—to C₂₀-aryl, C₇—to C₂₀-alkylaryl or phenyl, where any aromatic ring may also bear one or more, preferably one or two, C₁—to C₄-alkyl, C₁—to C₄-alkoxy, C₁—to C₄-hydroxyalkyl or C₁—to C₄-haloalkyl radicals as substituents, where not more than one of the variables R¹², R¹³ and R¹⁴ is hydrogen and at least one of the variables R¹², R¹³ and R¹⁴ is phenyl which may also bear one or more, preferably one or two, C₁—to C₄-alkyl, C₁—to C₄-alkoxy, C₁—to C₄-hydroxyalkyl or C₁—to C₄-haloalkyl radicals as substituents.

For the present invention, very particular preference is given to initiators selected from water, methanol, ethanol, 1-phenylethanol, 1-(p-methoxyphenyl) ethanol, n-propanol, isopropanol, 2-phenyl-2-propanol (cumene), n-butanol, isobutanol, sec.-butanol, tert-butanol, 1-phenyl-1-chloroethane, 2-phenyl-2-chloropropane (cumyl chloride), tert-butyl chloride and 1,3- or 1,4-bis(1-hydroxy-1-methylethyl)benzene. Among these, preference is given in particular to initiators selected from water, methanol, ethanol, 1-phenylethanol, 1-(p-methoxyphenyl) ethanol, n-propanol, isopropanol, 2-phenyl-2-propanol (cumene), n-butanol, isobutanol, sec.-butanol, tertbutanol, 1-phenyl-1-chloroethane and 1,3- or 1,4-bis(1-hydroxy-1-methylethyl)benzene.

Special preference is given to water.

### Starting Material for Polymerisation

For the use of isobutene or of an isobutene-comprising monomer mixture as the monomer to be polymerized, suitable isobutene sources are both pure isobutene and isobutenic C₄ hydrocarbon streams, for example C₄ raffinates, especially “raffinate 1”, C₄ cuts from isobutane dehydrogenation, C₄ cuts from steam crackers and from FCC crackers (fluid catalyzed cracking), provided that they have been substantially freed of 1,3-butadiene present therein. A C₄ hydrocarbon stream from an FCC refinery unit is also known as “b/b” stream. Further suitable isobutenic C₄ hydrocarbon streams are, for example, the product stream of a propylene-isobutane cooxidation or the product stream from a metathesis unit, which are generally used after customary purification and/or concentration. Suitable C₄ hydrocarbon streams generally comprise less than 500 ppm, preferably less than 200 ppm, of butadiene. The presence of 1-butene and of cis- and trans-2-butene is substantially uncritical. Typically, the isobutene concentration in the C₄ hydrocarbon streams mentioned is in the range from 40 to 60% by weight. For instance, raffinate 1 generally consists essentially of 30 to 50% by weight of isobutene, 10 to 50% by weight of 1-butene, 10 to 40% by weight of cis- and trans-2-butene, and 2 to 35% by weight of butanes; in the polymerization process according to the invention, the unbranched butenes in the raffinate 1 generally behave virtually inertly, and only the isobutene is polymerized.

In a preferred embodiment, the monomer source used for the polymerization is a technical C₄ hydrocarbon stream with an isobutene content of 1 to 100% by weight, especially of 1 to 99%by weight, in particular of 1 to 90% by weight, more preferably of 30 to 60% by weight, especially a raffinate 1 stream, a b/b stream from an FCC refinery unit, a product stream from a propylene-isobutane cooxidation or a product stream from a metathesis unit.

Especially when a raffinate 1 stream is used as the isobutene source, the use of water as the sole initiator or as a further initiator has been found to be useful, in particular when polymerization is effected at temperatures of −20° C. to +30° C., especially of 0° C. to +20° C. At temperatures of −20° C. to +30° C., especially of 0° C. to +20° C., when a raffinate 1 stream is used as the isobutene source, it is, however, also possible to dispense with the use of an initiator.

The isobutenic monomer mixture mentioned may comprise small amounts of contaminants such as water, carboxylic acids or mineral acids, without there being any critical yield or selectivity losses. It is appropriate to prevent enrichment of these impurities by removing such harmful substances from the isobutenic monomer mixture, for example by adsorption on solid adsorbents such as activated carbon, molecular sieves or ion exchangers.

It is also possible to convert monomer mixtures of isobutene or of the isobutenic hydrocarbon mixture with olefinically unsaturated monomers copolymerizable with isobutene. When monomer mixtures of isobutene are to be copolymerized with suitable comonomers, the monomer mixture preferably comprises at least 5% by weight, more preferably at least 10% by weight and especially at least 20% by weight of isobutene, and preferably at most 95% by weight, more preferably at most 90% by weight and especially at most 80% by weight of comonomers.

Useful copolymerizable monomers include: vinylaromatics such as styrene and α-methylstyrene, C₁—to C₄-alkylstyrenes such as 2-, 3- and 4-methylstyrene, and 4-tert-butylstyrene, halostyrenes such as 2-, 3- or 4-chlorostyrene, and isoolefins having 5 to 10 carbon atoms, such as 2-methylbutene-1, 2-methylpentene-1, 2-methylhexene-1, 2-ethylpentene-1, 2methylhexene-1 and 2-propylheptene-1. Further useful comonomers include olefins which have a silyl group, such as 1-trimethoxysilylethene, 1-(trimethoxysilyl) propene, 1-(trimethoxysilyl)-2-methylpropene-2, 1-[tri(methoxyethoxy)-silyl]ethene, 1-[tri(methoxyethoxy) silyl] propene, and 1-[tri(methoxyethoxy) silyl]-2-methylpro-pene-2. In addition-depending on the polymerization conditions-useful comonomers also include isoprene, 1-butene and cis- and trans-2-butene.

When the process according to the invention is to be used to prepare copolymers, the process can be configured so as to preferentially form random polymers or to preferentially form block copolymers. To prepare block copolymers, for example, the different monomers can be supplied successively to the polymerization reaction, in which case the second comonomer is especially not added until the first comonomer is already at least partly polymerized. In this manner, diblock, triblock and higher block copolymers are obtainable, which, according to the sequence of monomer addition, have a block of one or the other comonomer as a terminal block. In some cases, however, block copolymers also form when all comonomers are supplied to the polymerization reaction simultaneously, but one of them polymerizes significantly more rapidly than the other(s). This is the case especially when isobutene and a vinylaromatic compound, especially styrene, are copolymerized in the process according to the invention. This preferably forms block copolymers with a terminal polystyrene block. This is attributable to the fact that the vinylaromatic compound, especially styrene, polymerizes significantly more slowly than isobutene.

The polymerization can be effected either continuously or batchwise. Continuous processes can be performed in analogy to known prior art processes for continuous polymerization of isobutene in the presence of boron trifluoride-based catalysts in the liquid phase.

The process according to the invention is suitable either for performance at low temperatures, e.g. at −90° C. to 0° C., or at higher temperatures, i.e. at at least 0° C., e.g. at 0° C. to +30° C. or at 0° C. to +50° C. The polymerization in the process according to the invention is, however, preferably performed at relatively low temperatures, generally at −70° C. to −10° C., especially at −60° C. to −15° C.

When the polymerization in the process according to the invention is effected at or above the boiling temperature of the monomer or monomer mixture to be polymerized, it is preferably performed in pressure vessels, for example in autoclaves or in pressure reactors.

The polymerization in the process may be performed in the presence of an inert diluent. The inert diluent used should be suitable for reducing the increase in the viscosity of the reaction solution which generally occurs during the polymerization reaction to such an extent that the removal of the heat of reaction which evolves can be ensured. Suitable diluents are those solvents or solvent mixtures which are inert toward the reagents used. Suitable diluents are, for example, aliphatic hydrocarbons such as n-butane, n-pentane, n-hexane, n-heptane, n-octane and isooctane, cycloaliphatic hydrocarbons such as cyclopentane and cyclohexane, aromatic hydrocarbons such as benzene, toluene and the xylenes, and halogenated hydrocarbons, especially halogenated aliphatic hydrocarbons, such as methyl chloride, dichloromethane and trichloromethane (chloroform), 1,1-dichloroethane, 1,2-dichloroethane, trichloroethane and 1-chlorobutane, and also halogenated aromatic hydrocarbons and alkylaromatics halogenated in the alkyl side chains, such as chlorobenzene, monofluoromethylbenzene, difluoromethylbenzene and trifluoromethylbenzene, and mixtures of the aforementioned diluents. The diluents used, or the constituents used in the solvent mixtures mentioned, are also the inert components of isobutenic C₄ hydrocarbon streams. A non-halogenated solvent is preferred over the list of halogenated solvents.

The polymerization may be performed in a halogenated hydrocarbon, especially in a halogenated aliphatic hydrocarbon, or in a mixture of halogenated hydrocarbons, especially of halogenated aliphatic hydrocarbons, or in a mixture of at least one halogenated hydrocarbon, especially a halogenated aliphatic hydrocarbon, and at least one aliphatic, cycloaliphatic or aromatic hydrocarbon as an inert diluent, for example a mixture of dichloromethane and n-hexane, typically in a volume ratio of 10:90 to 90:10, especially of 50:50 to 85:15. Prior to use, the diluents are preferably freed of impurities such as water, carboxylic acids or mineral acids, for example by adsorption on solid adsorbents such as activated carbon, molecular sieves or ion exchangers.

In a preferred embodiment, the polymerization is performed in halogen-free aliphatic or especially halogen-free aromatic hydrocarbons, especially toluene. For this embodiment, water in combination with the organic hydroxyl compounds mentioned and/or the organic halogen compounds mentioned, or especially as the sole initiator, have been found to be particularly advantageous.

In another preferred embodiment, the polymerization is performed in halogen-free aliphatic or cycloaliphatic, preferably aliphatic hydrocarbons, especially hexane, pentane, heptane, cyclohexane, cyclopentane, and mixtures comprising them.

The polymerization is preferably performed under substantially aprotic and especially under substantially anhydrous reaction conditions. Substantially aprotic and substantially anhydrous reaction conditions are understood to mean that, respectively, the content of protic impurities and the water content in the reaction mixture are less than 50 ppm and especially less than 5 ppm. In general, the feedstocks will therefore be dried before use by physical and/or chemical measures. More particularly, it has been found to be useful to admix the aliphatic or cycloaliphatic hydrocarbons used as solvents, after customary prepurification and predrying with an organometallic compound, for example an organolithium, organomagnesium or organoaluminum compound, in an amount which is sufficient to substantially remove the water traces from the solvent. The solvent thus treated is then preferably condensed directly into the reaction vessel. It is also possible to proceed in a similar manner with the monomers to be polymerized, especially with isobutene or with the isobutenic mixtures. Drying with other customary desiccants such as molecular sieves or predried oxides such as aluminum oxide, silicon dioxide, calcium oxide or barium oxide is also suitable. The halogenated solvents for which drying with metals such as sodium or potassium or with metal alkyls is not an option are freed of water or water traces with desiccants suitable for that purpose, for example with calcium chloride, phosphorus pentoxide or molecular sieves. It is also possible in an analogous manner to dry those feedstocks for which treatment with metal alkyls is likewise not an option, for example vinylaromatic compounds. Even if some or all of the initiator used is water, residual moisture should preferably be very substantially or completely removed from solvents and monomers by drying prior to reaction, in order to be able to use the water initiator in a controlled, specified amount, as a result of which greater process control and reproducibility of the results are obtained.

The polymerization reaction is appropriately terminated by adding excess amounts of water or of basic material, for example gaseous or aqueous ammonia or aqueous alkali metal hydroxide solution such as sodium hydroxide solution.

After unconverted C₄ monomers have been removed, the crude polymerization product is typically washed repeatedly with distilled or deionized water, in order to remove adhering inorganic constituents. To achieve high purities or to remove undesired low and/or high molecular weight fractions, the polymerization reaction mixture can be fractionally distilled under reduced pressure.

The thus obtainable polyisobutene composition with a content of polyisobutene species (A) bearing an alpha-double bond of at least 70 mol % is subjected to the double bond isomerisation process described below.

It is also possible to use the reaction mixture from the polymerisation after desactivation of the catalyst and optionally after removal of the hydrolysis products by washing in the double bond isomerisation process without further purification. Besides the polyisobutene composition with a content of polyisobutene species (A) bearing an alpha-double bond of at least 70 mol % such a reaction mixture may contain unreacted monomer and lower oligomers of isobutene.

The undistilled reaction mixture differs from the polyisobutene composition insofar that it additionally comprises isobutene and those lower oligomers of isobutene which are usually separated from the reaction mixture by distillation.

Such lower oligomers of isobutene can be diisobutene, triisobutene, tetraisobutene, pentaisobutene, hexaisobutene, heptaisobutene, and octaisobutene. Higher oligomers of isobutene usually remain in the polyisobutene composition since they are not significantly volatile under distillation conditions, even under reduced pressure.

The content of unreacted isobutene may be up to 40 wt %, preferably up to 30 wt %, more preferably up to 20 wt %.

The content of unreacted lower oligomers mentioned above may be up to 5 wt %, preferably up to 3 wt %.

The distribution of double bond isomers (A), (B), and (C) among the oligomers is usually comparable to that of the polymer mixture, preferably it is the same. However, it has been observed that oligomer mixtures comprise less of isomer (C₆) compared with polymer mixtures, sometimes up to 5 mol % of isomer (C₆) less.

Hence, the content of oligomer species of formula (A) bearing an alpha-double bond is at least 70 mol %, preferably at least 75 mol %, more preferably at least 80 mol %, most preferably at least 85 mol % and especially at least 90 mol %.

For the isomerisation process it is possible to use a solution of the polyisobutene composition in at least one solvent as described above or to use the polyisobutene composition neat. In a preferred embodiment a 10 to 90 wt % solution of the polyisobutene composition in a solvent, preferably in a halid-free solvent is used in the double bond isomerisation process, preferably a 15 to 60 wt % solution, more preferably a 20 to50, and especially 25 to 40 wt % solution.

In one embodiment the solvent may be the inert components of isobutenic C₄ hydrocarbon streams.

After being subjected to the double bond isomerisation process the solvent in the reaction mixture is preferably removed, more preferably removed by way of distillation.

Usually a single step evaporation is sufficient without rectification equipment and can be effected in a falling-film evaporator, a rising-film evaporator, a thin-film evaporator, a long-tube evaporator, a helical tube evaporator, a forced-circulation flash evaporator or a paddle dryer, for example a Discotherm® dryer from List Technology AG, Switzerland, or a combination of these apparatuses.

The distillation is effected, as a rule, at 80-320° C., preferably 100-300° C., and 0.1-40, preferably 0.5-20 mbar.

Distillation may be assisted by leading an inert stripping through the evaporator, preferably nitrogen.

Such distillation and optionally stripping process yields a polyisobutene with a drastically reduced amount of solvent and monomer, even if n-hexane is used as a solvent. Therefore, another object of the invention are compositions in which the content of n-hexane is not more than 1000 ppm by weight, preferably not more than 900, more preferably not more than 800, and especially not more than 750 ppm by weight, and simultaneously the content of isobutene is not more than 50 ppm by weight, preferably not more than 40, more preferably not more than 30, and especially not more than 25 and even not more than 20 ppm by weight.

Such compositions are especially suitable for chewing gums or plasters.

### Isomerisation Process

According to another aspect of the present invention a polyisobutene composition with a content of polyisobutene species (A) bearing an alpha-double bond of at least 30 mol %, preferably at least 40 mol %, more preferably at least 50 mol %, most preferably at least 60 mol % and especially of at least 70 mol % is contacted with at least one acidic solid state catalyst, optionally treated with at least one Brønsted-base, and converted into a polyisobutene composition with a content of tetra substituted-double bond isomers (in sum), preferably isomers (C₃) to (C₅) of e.g. at least 5%, preferably from 10 to 90%, even more preferably from 15 to 80%, especially 20 to 75%, and even 25 to 60%.

With the process according to the invention usually 5 to 60%, preferably 20 to 50% (relative to the starting value) of the polyisobutene species (A) bearing an alpha-double bond are converted into polyisobutene species with tetra substituted-double bond isomers (in sum), preferably isomers (C3) to (C5).

Optionally such a composition may comprise up to 20 mol % (in sum) polyisobutene isomers (C) and (D) other than tetra substituted-double bond isomers, wherein the sum of (A), (B), (C), and (D) always adds up to 100 mol %.

It is an advantage of that process according to the invention that in low or medium molecular polyisobutene isomers (A) with an alpha-double bond may be converted into isomers with a tetra substituted-double bond.

The above-mentioned process is carried out at a temperature of from 40° C. to 250° C., preferably 50 to 230, more preferably 60 to 200, even more preferably 70 to 180 and especially 80 to 160° C. for a period of from 10 minutes to 36 hours, preferably 15 minutes to 24 hours, more preferably 30 minutes to 12 hours, and especially 1 to 6 hours.

Optimum contact time of the polyisobutene composition with the catalyst and reaction temperature can be determined by systematic variation of the reaction parameters.

In the case of a ion exchange resin (see below) the reaction temperature should not exceed 150° C., preferably not higher than 140, more preferably not higher than 130, even more preferably not higher than 120° C., especially not higher than 110° C.

As a rule polyisobutene with a high content of isomers with an alpha-double bond is first converted into polyisobutene isomers with a trisubstituted double bond, preferably isomer (B) and afterwards into isomers with a tetrasubstituted double bond. Hence, if a higher content of trisubstituted double bond, preferably isomer (B) is desired the reaction time should be chosen shorter, preferably up to 4 hours, more preferably up to 3 hours, even more preferably up to 2 hours or even up to 1 hours depending on the reaction temperature. Also, the reaction temperature should be chosen lower, e.g. up to 130° C., preferably up to 120° C., more preferably up to 110° C., even more preferably up to 100° C., especially up to 90° C., and even up to 80° C.

If a higher content of isomers with a tetrasubstituted double bond is desired, the reaction time should be chosen longer, preferably more than 4 hours, more preferably at least 5 hours, even more preferably at least 6 hours. A higher reaction temperature is preferred in order to favour equilibration.

Examples of acidic solid state catalysts are those which exhibit a temperature programmed desorption (TPD) of ammonia which is above the physical adsorption. A method for the determination of the temperature programmed desorption (TPD) of ammonia can be found in Philip M. Kester, Jeffrey T. Miller, and Rajamani Gounder, Ammonia Titration Methods To Quantify Brønsted Acid Sites in Zeolites Substituted with Aluminum and Boron Heteroatoms, Industrial & Engineering Chemistry Research 2018 57 (19), 6673-6683, Chapter 2.3.

Preferably the acidic solid state catalysts are selected from the group consisting of
Natural clay minerals: kaolinite, bentonite, attapulgite, montmorillonite, clarit, fuller's earth, zeolites (X, Y, A, H-ZSM etc), cation exchanged zeolites, and clays
Mounted acids: H₂SO₄, H₃PO₄, CH₂(COOH)₂ mounted on silica, quartz sand, alumina or diatomaceous earth
Cation exchange resins
Metal oxides and sulfides: ZnO, CdO, Al₂O3, CeO₂, ThO₂, TiO₂, ZrO₂, SnO₂, PbO, As₂O₅, Bi₂O3, Sb₂O₅, V₂O₅, Cr₂O₃, MoO₃, WO3, CdS, ZnS
Metal salts: MgSO₄, CaSO₄, SrSO₄, BaSO₄, CuSO₄, ZnSO₄, CdSO₄, Al₂(SO₄)₃, FeSO₄, Fe₂(SO₄)₃, CoSO₄, NiSO₄, Cr₂ (SO₄)₃, KHSO₄, K₂SO₄, (NH₄)₂SO₄, Zn(NO₃)₂, Ca(NO₃)₂, Bi(NO₃)₃, Fe(NO₃)₃, CaCO₃, BPO₄, AlPO₄, CrPO₄, FePO₄, Cu₃(PO₄)₂, Zn₃(PO₄)₂, Mg₃(PO₄)₂, Ti₃(PO₄)₄, Zr₃(PO₄)₄, Ni₃(PO₄)₂, AgCl, CuCl, CaCl₂), AlCl₃, TiCl₄, SnCl₄, CaF₂, BaF₂, AgClO₄, Mg(ClO₄)₂,
Mixed oxides: SiO₂—Al₂O₃, SiO₂—TiO₂, SiO₂—SnO₂, SiO₂—ZrO₂, SiO₂—BeO, SiO₂—MgO, SiO₂—CaO, SiO₂—SrO, SiO₂—ZnO, SiO₂—Ga2O₃, SiO₂—Y₂O₃, SiO₂—La₂O₃, SiO₂—MoO₃, SiO₂—WO3, SiO₂—V₂O₅, SiO₂—ThO₂, Al₂O, —MgO, Al₂O₃—ZnO, Al₂O₃—CdO, Al₂O₃—B2O₃, Al₂O₃—ThO₂, Al₂O₃—TiO₂, Al₂O₃—ZrO₂, Al₂O₃—V₂O₅, Al₂O₃—MoO₃, Al₂O₃—WO3, Al₂O₃—Cr₂O₃, Al₂O₃—Mn₂O₃, Al₂O₃—Fe₂O₃, Al₂O₃—Co₃O₄, Al₂O₃—NiO, TiO₂—CuO, TiO₂—MgO, TiO₂—ZnO, TiO₂—CdO, TiO₂—ZrO₂, TiO₂—SnO₂, TiO₂—Bi₂O₃, TiO₂—Sb2O₅, TiO₂—V₂O₅, TiO₂—Cr₂O₃, TiO₂-MOO₃, TiO₂—WO3, TiO₂—Mn₂O₃, TiO₂—Fe₂O₃, TiO₂—CO₃O₄, TiO₂—NiO, ZrO₂—CdO, ZnO—MgO, ZnO—Fe₂O₃, MoO₃—CoO—Al₂O₃, MoO₃—NiO—Al₂O₃, TiO₂—SiO₂—MgO, MoO₃—Al₂O₃—MgO, heteropoly acids.

More preferably the acidic solid state catalyst is selected from the group consisting of SiO₂, Al₂O₃, TiO₂, ZrO₂, B2O₃, ZnO₂, Nb₂O₅ or mixtures thereof.

Very preferably the acidic solid state catalyst is selected from the group consisting of silicates, alumina, silico-aluminates, and zeolites.

Especially the acidic solid state catalyst is a molecular sieve.

The average pore diameter of such molecular sieves is from 0.1 to 1 nm (1 to 10 Å), preferably from 0.1 to 0.6, more preferably from 0.2 to 0.5 nm.

Such molecular sieves are aluminosilicates with a silica-alumina ratio (SiO₂/Al₂O₃) of from 1:0.1 to 1:5, preferably from 1:0.2 to 1:3, and more preferably of 1:0.2 to 1:1, especially 1:0. 5.

The approximate chemical composition of such aluminosilicates is
[(K₂O)ₓ (Na₂O)_{y}]·Al₂O₃·2SiO₂. 9/2 H₂O
with
x from 0 to 1, preferably from 0 to 0.7, more preferably from 0 to 0.5, especially 0,
y from 0 to 1, preferably from 0.3 to 1, more preferably from 0.5 to 1, especially 1,
wherein x+y=1.

In a preferred embodiment the acidity of the acidic solid state catalysts is adjusted by treatment with at least one Brønsted-base, preferably at least one inorganic base, more preferably hydroxides, oxides, C₁-C₄-carboxylates, preferably formiates or acetates, more preferably acetates, carbonates or hydrogen carbonates of alkaline or earth alkaline metals, even more preferably of sodium, potassium or calcium.

For this purpose the acidic solid state catalyst is treated with an aqueous solution of the Brønsted-base in an amount sufficient to yield the desired acidity, and afterwards dried or calcinated.

Preferably the impregnated solid state catalyst is calcinated at a temperature of from 400 to 1000° C.

With such a treatment it is possible to adjust the acidity and, therefore, the reactivity of a solid state catalyst so that the reaction can be terminated when the concentration of the desired isomer with tetra-substituted double bonds in the reaction mixture is at its maximum while side- or follow up-reactions-do not occur significantly.

In a preferred embodiment the solid state catalyst comprises an alumina component, a zeolite component and optionally an added metal component as the Brønsted-base, preferably the added metal component is present in the solid state catalyst. In a preferred embodiment the solid state catalyst is used as described in U.S. Pat. No. 8,147,588 B2, preferably as described therein from column 2, line 50 to column 5, line 32, which is incorporated herein by reference.

The acidic solid state catalyst, optionally treated with at least one Brønsted-base or ion exchanger can be used in different geometrical shapes, such as powder, granules, beads, spheres, saddles, extrudates, strands, pellets, tablets or meshs.

The catalyst load, calculated as kg polyisobutene composition per kg solid state catalyst and hour reaction time, can vary from 0.1 to 10, preferably from 0.2 to 8, more preferably from 0.5 to 5 kg/(kg×h).

In a preferred embodiment the process according to the invention is conducted in the presence of at least one initiator compound described above, more preferably in the presence of water or at least one organic hydroxyl compound, and very preferably in the presence of water.

For this purpose the polyisobutene composition with a content of polyisobutene species (A) as a starting material is contacted with the acidic solid state catalyst, optionally treated with at least one Brønsted-base in the presence of up to 5 wt % (relative to the polyisobutene species (A)) of the at least one initiator, preferably up to 3 wt %, more preferably up to 2 wt %, and especially up to 1 wt %.

The process can optionally be conducted in the presence of at least one solvent, preferably in the presence of at least one solvent.

As solvent those solvents may be used which are listed above in the context of the polymerisation, preferred are non-halogenated solvents, more preferred are aliphatic or aromatic hydro-carbons, especially aliphatic hydrocarbons.

In a preferred embodiment the solvent, especially the hydrocarbon, is treated with water, preferably saturated with water prior to conducting the isomerisation reaction and the reaction is thus conducted in the presence of a solvent together with water.

The isomerisation process can be conducted in a continuous or discontinuous manner, preferably continuously.

For a discontinuous reaction polyisobutene composition, optional solvent, and solid state catalyst are placed together in a reactor, heated to the temperature desired and the reaction is conducted under stirring or pumping the reaction mixture in a circular flow.

For a continuous reaction polyisobutene composition, optional solvent, and solid state catalyst are conveyed through a reactor in upflow or downflow procedure, heated to the temperature desired and the reaction is conducted. The liquid flow through the reactor is adjusted so that the residence time in the reactor corresponds to the reaction time desired.

Usually the reaction can be conducted at atmospheric pressure, higher pressure may be helpful to prevent the optional solvent from evaporating so that the reaction mixture remains in a single liquid phase.

The Langmuir specific surface area of the acidic solid state catalyst, optionally treated with at least one Brønsted-base, employed in the process according to the invention is preferably from 50 to 1000 m²/g, more preferably from 75 to 900 m²/g, particularly preferably from 100 to 800 m²/g, even more preferably 200 to 700, and especially 300 to 500 m²/g. The Langmuir surface area is determined by nitrogen absorption using the DIN 66132 method.

The pore volume of the acidic solid state catalyst, optionally treated with at least one Brønsted-base, determined by mercury porosimetry is preferably from 0.01 to 0.3 ml/g, more preferably from 0.03 to 0.2 ml/g. The average pore diameter determined by this method is preferably from 0.1 to 10 nm, more preferably from 0.2 to 9 nm, and more preferably from 0.3 to 5 nm.

The mercury pore volume and the pore diameter of pores with 0.3 nm or higher are determined by the DIN 66133 method, for smaller pore diameters the nitrogen pore volume is used.

The acidity/basicity of the solid state catalyst is determined using the pH-value of an aqueous slurry of the solid state catalyst, see below in the Analytical Method section.

Preferred solid state catalysts without treatment with a Brønsted-base exhibit a pH-value in the form of a 10 wt % aqueous slurry from 3 to 8, preferably from 3.5 to 7, more preferably from 4 to 6, and especially from 4 to 5.5.

Preferred solid state catalysts treated with at least one Brønsted-base exhibit a pH-value in the form of a 10 wt % aqueous slurry from 6 to 13, preferably from 7 to 12.5, more preferably from 8 to 12, and especially from 9 to 11.5.

In an especially preferred embodiment acidic ion exchangers may be used as acidic solid state catalyst, preferably strongly acidic ion exchangers.

Ion exchanger resins usually are based upon styrene or (meth)acrylic acid. Weakly acidic ion exchangers are often based on polymers comprising (meth)acrylic acid with carboxylic acid groups as acidic groups. Strongly acidic ion exchangers are usually based on styrene-divinyl styrene copolymers bearing sulfonic acid groups. Since the backbone of the polymer is organic the reaction temperature should not be raised above a certain limit, see above. An exception are perfluorinated polymers, such as Nafion® ion exchangers which can also be used at higher temperatures. Further examples of commercially available ion exchangers are acidic ion exchangers of from the Amberlyst® or Amberlite® product range.

In the case of acidic ion exchangers the concentration of acid sites based on the dry weight capacity should be at least 1.0 eq/kg, preferably at least 1.5, more preferably at least 2.0, even more preferably at least 2.5, and especially at least 3 eq/kg. The concentration of acid sites usually does not exceed 10.0 eq/kg.

Preferred ion exchangers exhibit a nitrogen BET surface area from 10 to 100, preferably 20 to 80, and very preferably from 30 to 70 m²/g.

Preferably the average pore diameter of ion exchangers is from 50 to 1000 Å (Angström), more preferably from 100 to 800, and more preferably from 200 to 500 Å.

The total pore volume is preferably from 0.1 to 0.9 ml/g, more preferably from 0.2 to 0.8, and even more preferably 0.3 to 0.7 ml/g.

In a preferred embodiment ion exchanger is used in the form of beads, preferably with an average diameter from 0.1 to 5 mm, more preferably from 0.2 to 3 mm, and even more preferably from 0.3 to 2.5 mm.

Usually a high concentration of acid sites is preferred.

Surprisingly the process according to the present invention yields compositions with an increased content of polyisobutene species bearing a tetra-substituted double bond, preferably selected from the group consisting of isomers (C3), (C4), and (C5).

Such compositions with an increased content of polyisobutene species bearing a tetra-substituted double bond are of very high reactivity in photo reactions, preferably photo oxygenation and, therefore, provide an excellent use as starting materials for chemical modification of such compositions, if a photo reaction is wanted.

The NMR spectroscopy of the polyisobutene polymers was performed as described in Guo et al., Journal or Polymer Science, Part A: Polymer Chemistry, 2013, 51, 4200-4212, on a Bruker 700 MHz spectrometer using 5 mm o.d. tubes with appropriate concentration of polyisobutene in deuterated chloroform (CDCl₃) as a solvent at 25° C. The 1H spectra of polyisobutene solutions in CDCl₃ were calibrated to tetramethylsilane as internal standard (δ_{H}=0.00) or to the solvent signal (δ_{C}=77.0), respectively. The distortionless enhancement by polarization transfer (DEPT) technique was further used for structural characterization of polyisobutenes.

The examples which follow are intended to illustrate the present invention in detail without restricting it.

### EXAMPLES

### Example 1

To achieve a polyisobutene with the desired reactivity, isobutene was polymerized in hexane with the catalyst: co-catalyst ratio stated in the table below and contacted with an isomerisation catalyst in a fixed bed isomerisation tower at elevated temperatures (concentration polyisobutene in hexane: 35 wt %). Subsequently, the solution of polyisobutene in hexane was exposed to elevated temperatures in the degassing section for 90 min at 25 mbar (abs) (refer to table below for further details).

The isomerisation catalyst applied was a spherical alumina-zeolite composite, surface area 390 m²/g, pH-value of the slurry: 11.3

| | | | | | | | | | | | (C3) + (C4) + |
|---|---|---|---|---|---|---|---|---|---|---|---|
| | | | (c) | (d) | (e) | | (A) | (C6) + (C8) | (B) + (C7) | (C1) + (C2) | (C5) + (C7) |
| €. | (a) | (b) | ° C. | hrs | ° C. | Mn | % | % | % | % | % |
| 1 | 0.9 | 0.6 | 0 | 0 | 175 | 19850 | 59 | 17 | 15 | 2 | 7 |
| 1a | 0.9 | 0.6 | 50 | 0.5 | 175 | 19840 | 33 | 14 | 27 | 2 | 18 |
| 2 | 0.9 | 0.6 | 70 | 1 | 185 | 19850 | 19 | 10 | 37 | 2 | 32 |
| 3 | 0.9 | 0.6 | 100 | 1 | 185 | 19830 | 15 | 6 | 41 | 2 | 36 |
| 4 | 0.9 | 0.6 | 130 | 2 | 200 | 19810 | 9 | 4 | 34 | 2 | 51 |
| 5 | 1.5 | 1.1 | 0 | 0 | 175 | 18940 | 75 | 4 | 12 | 1 | 8 |
| 6 | 1.5 | 1.1 | 70 | 1 | 185 | 18935 | 55 | 4 | 31 | 1 | 9 |
| 7 | 1.5 | 1.1 | 130 | 1 | 185 | 18920 | 22 | 2 | 41 | 1 | 34 |
| 8 | 1.0 | 0.5 | 50 | 3 | 175 | 19560 | 7 | 2 | 48 | 2 | 41 |

(a) amount of catalyst [gr BF₃/kg polyisobutene]
(b) amount of cocatalyst/catalyst [gr isopropanol/kg polyisobutene]
(c) contact temperature with isomerisation catalyst
(d) contact time with isomerisation catalyst
(e) degassing temperature

### Example 2-Isomerisation of Medium Molecular Polyisobutene

Medium molecular polyisobutene with a number-average molecular weight Mn of 18330 g/mol and a polydispersity of 3.2 was dissolved in heptane to obtain a 35 wt % solution.

The solution was heated to 80° C. in a flask with reflux condenser for 6 hours together with 10 wt % (based on polyisobutene) of the isomerisation catalyst listed in the table. After 6 hours a sample was taken and the distribution of isomers was determined with ¹H-NMR according to the method described above and the number average molecular weight determined using GPC.

| | | Tri- | Tetra- | |
|---|---|---|---|---|
| Isomerisation | Vinyliden | substituted | substituted | Mn |
| Catalyst | Content (a) | Isomers (b) | Isomers (c) | [g/mol] |
| — (d) | 42.0 | 44.1 | 13.8 | 18330 |
| Molecular | 28.4 | 29.0 | 38.4 | 23262 |
| Sieve 5Å | | | | |
| (e) Ion | 21.5 | 44.0 | 34.6 | 8262 |
| Exchanger | | | | |

(a) Isomer (A) with alpha-double bond
(b) Trisubstituted isomers (B), (C1), (C2), and (C7) (in sum)
(c) Tetrasubstituted isomers (C3), (C4), and (C5) (in sum)
(d) Medium molecular polyisobuten as starting material
(e) Amberlyst 15 as strongly acidic ion exchanger

### Example 3-Isomerisation of Low Molecular Polyisobutene

As described in Example 2 low molecular weight highly reactive polyisobutene with a number average molecular weight Mn of 973 g/mol was isomerised with 10 wt % Amberlyst® 15 as strongly acidic ion exchanger. Every 2 hours a sample was taken and analysed as outlined in

| | | Tri- | Tetra- | |
|---|---|---|---|---|
| Reaction | Vinyliden | substituted | substituted | Mn |
| Time [h] | Content (a) | Isomers (b) | Isomers (c) | [g/mol] |
| 0 | 87.2 | 10.5 | 1.5 | 973 |
| 2 | 28.3 | 47.1 | 24.6 | 1195 |
| 4 | 20.0 | 43.1 | 36.9 | 1166 |
| 6 | 15.3 | 39.6 | 45.0 | 1097 |

(a) Isomer (A) with alpha-double bond
(b) Trisubstituted isomers (B), (C1), (C2), and (C7) (in sum)
(c) Tetrasubstituted isomers (C3), (C4), and (C5) (in sum)

It can easily be seen that the alpha-double bond is first isomerised to isomers with a trisubstituted double bond and later to isomers with a tetra-substituted double bond.

Without wishing to be bound to a theory it can be assumed that the isomerisation to isomers with a trisubstituted double bond takes place under kinetic control while the conversion to isomers with a tetra-substituted double bond proceeds under thermodynamic control.

1-15. (canceled)

16. A medium molecular polyisobutene composition with a number average molecular weight Mn of more than 10000 to 100000 g/mol determined by gel permeation chromatography comprising 20 to 75% (in sum) of at least one isomer bearing a tetra-substituted double bond, selected from the group consisting of 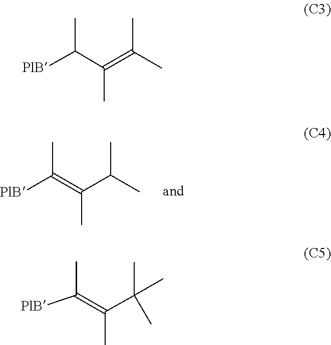
in which PIB, PIB′ and PIB″ refer to appropriately shortened polymeric backbones of the polyisobutene.

17. The medium molecular polyisobutene composition according to claim 16, wherein the medium molecular polyisobutene composition has a number average molecular weight Mn of from 13000 to 75000 g/mol determined by gel permeation chromatography.

18. The medium molecular polyisobutene composition according to claim 16, comprising:
halogenated polyisobutenes (D1) in amounts that an upper limit of the halogen is 500 ppm by weight.

19. A method, comprising: reacting the medium molecular polyisobutene composition according to claim 16 in a photo reaction.

20. A sealant, adhesive, coating, or roofing, comprising: the medium molecular polyisobutene composition according to claim 16.

21. A process for preparation of the medium molecular polyisobutene composition according to claim 16, the process comprising:
choosing as a starting material a medium molecular polyisobutene composition with a number average molecular weight Mn of more than 10000 to 100000 g/mol determined by gel permeation chromatography with a content of polyisobutene species (A) bearing an alpha-double bond of at least 30 mol %,
optionally at least one solvent,
treating the optionally dissolved polyisobutene composition:
in the presence of at least one acidic solid state catalyst, optionally treated with at least one Brønsted-base;
for a period of from 10 minutes to 36 hours; and
at a temperature of from 40° C. to 250° C.

22. The process according to claim 21, wherein the at least one acidic solid state catalyst is selected from the group consisting of
natural clay minerals: kaolinite, bentonite, attapulgite, montmorillonite, clarit, fuller's earth, zeolites (X, Y, A, H-ZSM etc), cation exchanged zeolites, and clays;
mounted acids: H₂SO₄, H₃PO₄, CH₂(COOH)₂ mounted on silica, quartz sand, alumina or diatomaceous earth;
cation exchange resins;
metal oxides and sulfides: ZnO, CdO, Al₂O₃, CeO₂, ThO₂, TiO₂, ZrO₂, SnO₂, PbO, As₂O₅, Bi₂O3, Sb2O₅, V₂O₅, Cr₂O₃, MoO₃, WO3, CdS, ZnS;
metal salts: MgSO₄, CaSO₄, SrSO₄, BaSO₄, CuSO₄, ZnSO₄, CdSO₄, Al(SO₄)₃, FeSO₄, Fe₂ (SO₄)₃, CoSO₄, NiSO₄, Cr₂ (SO₄)₃, KHSO₄, K₂SO₄, (NH₄)₂SO₄, Zn(NO₃)₂, Ca(NO₃)₂, Bi(NO₃)₃, Fe(NO₃)₃, CaCO₃, BPO₄, AlPO₄, CrPO₄, FePO₄, Cu₃(PO₄)₂, Zn₃(PO₄)₂, Mg₃(PO₄)₂, Ti₃(PO₄)₄, Zr₃(PO₄)₄, Ni₃(PO₄)₂, AgCl, CuCl, CaCl₂), AlCl₃, TiCl₄, SnCl₄, CaF₂, BaF₂, AgClO₄, Mg(ClO₄)₂; and
mixed oxides: SiO₂—Al₂O₃, SiO₂—TiO₂, SiO₂—SnO₂, SiO₂—ZrO₂, SiO₂—BeO, SiO₂—MgO, SiO₂—CaO, SiO₂—SrO, SiO₂—ZnO, SiO₂—Ga₂O₃, SiO₂—Y₂O₃, SiO₂—La₂O₃, SiO₂—MoO₃, SiO₂—WO3, SiO₂—V₂O₅, SiO₂—ThO₂, Al₂O, —MgO, Al₂O₃—ZnO, Al₂O₃—CdO, Al₂O₃—B₂O₃, Al₂O₃—ThO₂, Al₂O₃—TiO₂, Al₂O₃—ZrO₂, Al₂O₃—V₂O₅, Al₂O₃—MoO₃, Al₂O₃—WO3, Al₂O₃—Cr₂O₃, Al₂O₃—Mn₂O₃, Al₂O₃—Fe₂O₃, Al₂O₃—Co₃O₄, Al₂O₃—NiO, TiO₂—CuO, TiO₂—MgO, TiO₂—ZnO, TiO₂—CdO, TiO₂—ZrO₂, TiO₂—SnO₂, TiO₂—Bi₂O₃, TiO₂—Sb2O₅, TiO₂—V₂O₅, TiO₂—Cr₂O₃, TiO₂—MoO₃, TiO₂—WO3, TiO₂—Mn₂O₃, TiO₂—Fe₂O₃, TiO₂—Co₃O₄, TiO₂—NiO, ZrO₂—CdO, ZnO—MgO, ZnO—Fe₂O₃, MoO₃—CoO—Al₂O₃, MoO₃—NiO—Al₂O₃, TiO₂—SiO₂—MgO, MoO₃—Al₂O₃—MgO, heteropoly acids.

23. The process according to claim 22, wherein the temperature is from 40° C. to 250° C. for a period of from 10 minutes to 36 hours.

24. The process according to claim 22, wherein the at least one acidic solid state catalyst is an acidic ion exchanger.

25. The process according to claim 24, wherein the reaction temperature does not exceed 150° C.

26. The process according to claim 24, wherein a concentration of acid sites of the acidic ion exchanger based on a dry weight capacity is at least 1.0 eq/kg.

27. The medium molecular polyisobutene composition according to claim 16, wherein a content of halogen is more than 5 ppm by weight.

28. The medium molecular polyisobutene composition according to claim 27, wherein an upper limit of the halogen is up to 500 ppm by weight.

29. The medium molecular polyisobutene composition according to claim 16, comprising:
to 60% of at least one isomer bearing a tetra-substituted double bond.

30. The polyisobutene composition according to claim 17, wherein the medium molecular polyisobutene composition has a number average molecular weight Mn of from 14000 to 70000 determined by gel permeation chromatography.

31. The process according to claim 21, wherein the medium molecular polyisobutene composition has a number average molecular weight Mn of from 14000 to 70000 g/mol.

32. The process according to claim 23, wherein the temperature is from 80 to 160° C. for a period of from 1 to 6 hours.

33. The process according to claim 25, wherein the reaction temperature does not exceed 110° C.

34. The process according to claim 26, wherein the concentration of acid sites of the acidic ion exchanger based on a dry weight capacity is at least 3 eq/kg.

35. The polyisobutene composition according to claim 27, wherein the content of halogen is at least 70 ppm by weight.
